(19) United States
(12) Patent Application Publication
(10) Pub. No.: US 2006/0223586 A1
(43) Pub. Date: Oct. 5, 2006

(54) Transport resource control system and method, and radio network controller used in the same

(75) Inventor: Satoshi Noma, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/377,372

(22) Filed: Mar. 17, 2006

(30) Foreign Application Priority Data
Mar. 30, 2005 (JP) 2005-096639

(51) Int. Cl. H04B 1/38; H04M 1/00

(52) U.S. Cl. 455/560

(57) ABSTRACT

A W-CDMA mobile communication system, capable of providing, between T-plane and C-plane, a control system for transport resources with high independency and simplicity, which controls transport resources through respective interfaces between RNC and CN, RNC, Node B by linking a call in mobile terminal with call information “1” to “4” in CID unit of ALCAP and defining single identifiers “1” to “4” of single identifiers (call information) in a call of the mobile terminal.

### BACKGROUND OF THE INVENTION

1. Field of the Invention

The present invention relates to a transport resource control system and method, and a radio network controller used in the same, and in particular to a transport resource control system in a mobile communication system adaptable to communications through a mobile terminal by ensuring transport resources in respective interfaces between a core network, a radio network controller and a base station.

2. Description of the Prior Art

FIG. 6 illustrates an architecture of a W-CDMA mobile communication system. As illustrated in FIG. 6, this system consists of a CN (core network) 10, RNCs (Radio Network Controllers) 20, 30 and Nodes B (radio base stations) 40, 50, 60, 70. The RNC20 and RNC30 are connected to the CN10 through Iu interfaces, and connected to the Nodes B40, 50 and 60, 70 through Iub interfaces. Moreover, the RNC20 and RNC30 are connected to each other through an Iur interface.

Such an architecture as illustrated in FIG. 6, detailed in 3GPP (3rd Generation Partnership Project), is known and disclosed in Japanese Patent Laid-Open No. 2002-199440, Japanese Patent Laid-Open No. 2003-283596 and Japanese Patent Laid-Open No. 2004-007084 as well.

For a mobile terminal (not illustrated) to transmit and receive data to/from a network side including the CN10 through Node B in such a mobile communication system, transport resources in the respective interfaces of Iub, Iur, Iu are required to ensure as necessary. Where an ATM network is used as the transport resource, the transport resources are ensured between the RNC20, RNC30 and Nodes B40, 50, 60, 70, using a control protocol for a transport layer, called an ALCAP (Access Link Control Application Part) protocol.

In the ALCAP protocol, the transport resource is expressed with identification data called CID (Channel Identifier). The CID is unique for each of the services such as CS (Circuit Switch) or PS (Packet Switch) required by users. A plurality of CIDs are used in the respective interfaces Iu, Iur, Iub for the mobile terminal. Moreover, the respective CIDs are independently allocated to the respective interfaces.

Accordingly, where the Node B ensures a plurality of CIDs as transport resources for a mobile terminal, a relationship of the plurality of CIDs is not possible to be grasped only by the data accompanied by the ALCAP protocol. To address such a problem, linkage to a protocol, which is called an NBAP (Node B Application Part) protocol and negotiates wireless resources between the Node B and the RNC, is required in addition to the ALCAP protocol.

An explanation will be made below, using FIG. 7. The ALCAP and NBAP between the RNC and Node B are protocols for transport/wireless resource control as described above. In the NBAP, a call is set for each mobile terminal and, in RNC/Node B. each of them is identified as “I” and “II” for the call.

At the same time, an identifier called a binding ID used in the ALCAP is exchanged between the RNC and Node B. In the ALCAP, CID setting is made a long with the binding ID. In FIG. 7, the CID is designated as “A”. Such a linkage between two protocols of the NBAP and the ALCAP can discriminate which CID corresponds to a call “I” or “II”.

The above-mentioned CIDs are allocated for each interface in addition to each mobile terminal, and FIG. 8 illustrates an example of detailed allocation. If a total of four calls (a to d) exist as shown in FIG. 8, A to D are allocated respectively as the CIDs in the Iu interface. On the other hand, in the Iur interface, A and B are allocated as CIDs and, in the Iub interface, A to F are allocated as CIDs.

Because the CIDs are allocated for each interface in this way, an overlapped CID is sometimes allocated if the interface is different. As shown in an example of FIG. 8, C is overlapped between the Iu and Iub.

Because it is discriminated which CID is allocated to a mobile terminal as described in FIG. 7 linkage of two protocols of the NBAP and ALCAP is required, which causes a problem that independence is insufficient as a transport resource control protocol. As described in FIG. 8, the respective Iub, Iur and Iu interfaces control CIDs, and CID control becomes complicated, which causes a problem that the RNC cannot use an identifier expressing transport resources for each mobile terminal.

In view of the aforementioned problems, it is an object of the present invention to provide a transport resource control system and method, and a radio network controller with high independency and high simplicity.

### BRIEF SUMMARY OF THE INVENTION

A transport resource control system according to the present invention is used in a mobile communication system adaptable to communications through a mobile terminal by ensuring transport resources in respective interfaces between a core network, a radio network controller and a base station, wherein the transport resource control system comprises control section for controlling the transport resources using call information as unique identification data at every call for the mobile terminal.

A transport resource control method according to the present invention is used in a mobile communication system adaptable to communications through a mobile terminal by ensuring transport resources in respective interfaces between a core network, a radio network controller and a base station, wherein the transport resource control method comprises a control step of controlling the transport resources using call information as unique identification data at every call for the mobile terminal.

A radio network controller according to the present invention is used in a mobile communication system adaptable to communications through a mobile terminal by ensuring transport resources in respective interfaces between a core network, the radio network controller and a base station, wherein the radio network controller includes control section for controlling the transport resources using call information as unique identification data at every call for the mobile terminal.

A program according to the present invention enables a computer to perform operations of a radio network controller in a mobile communication system adaptable to communications through a mobile terminal by ensuring transport resources in respective interfaces between a core network, the radio network controller and a base station, wherein the program comprises a process of controlling the transport resources using call information as unique identification data at every call for the mobile terminal.

### BRIEF DESCRIPTION OF THE DRAWINGS

FIG. 1 is a block diagram illustrating one embodiment of the present invention;

FIG. 2 is a sequence diagram illustrating operations of one embodiment of the present invention;

FIG. 3 is a sequence diagram illustrating operations of another embodiment of the present invention;

FIG. 4 is a block diagram for better understanding of one embodiment of the present invention;

FIG. 5 is a chart showing an example of CID/call information allocation in an example of FIG. 4;

FIG. 6 is a block diagram of W-CDMA communication system applied with the present invention;

FIG. 7 is a diagram illustrating control protocol for transport resources in an Iub interface between RNC and Node B; and

FIG. 8 is a chart showing an example of CID allocation in respective interfaces illustrated in FIG. 6.

### DETAILED DESCRIPTION OF THE PREFERRED EMBODIMENTS

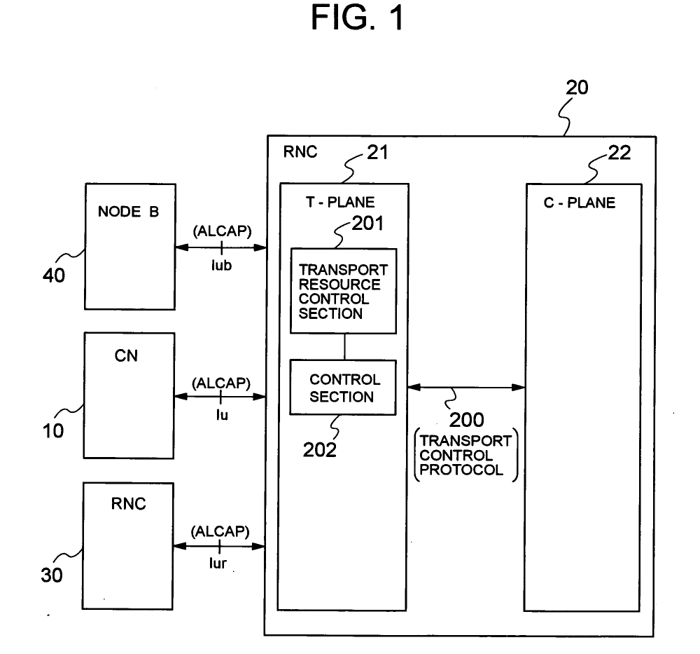

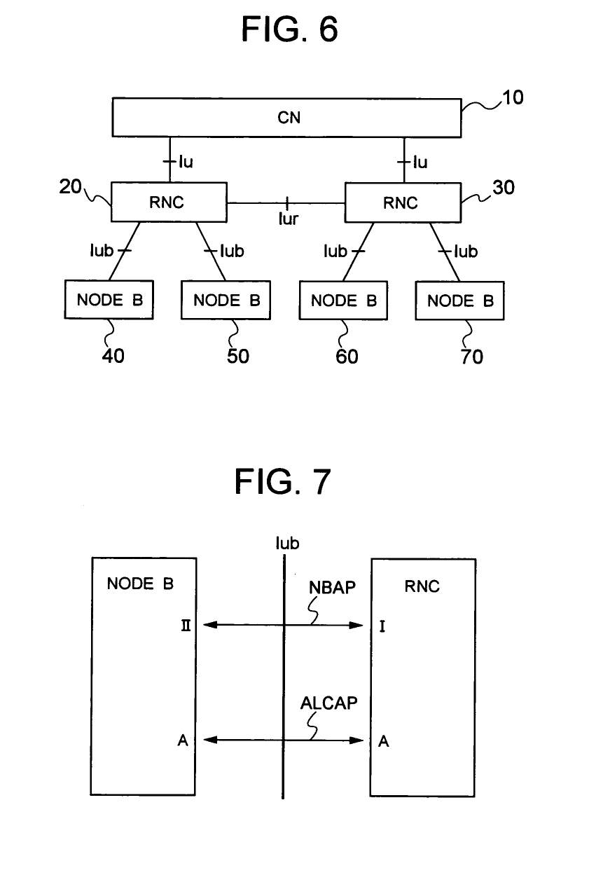

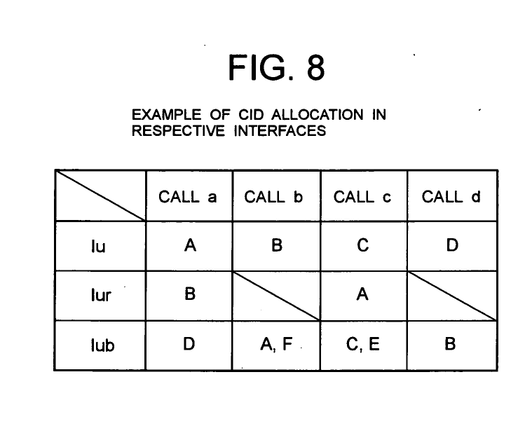

Hereinafter, referring to the accompanying drawings, embodiments of the present invention will be explained in detail. FIG. 1 is a schematic block diagram illustrating one embodiment of the present invention, of which equivalents to those in FIG. 6 are shown by the same symbols.

As illustrated in FIG. 1, the RNC20 in this embodiment includes a T (Transport) plane (T-plane) 21 and a C (Control) plane (C-plane) 22. The RNC is generally divided into three sections in function: the C-plane for signaling transmitting a control signal, a U (User) plane transmitting users' data and the T-plane controlling transport, but, the present invention omits the U-plane because it has no particular relationship.

The C-plane undergoes signal processing such as RRC/RNSAP/RANAP/NBAP, the T-plane performs signal processing such as ALCAP/AAL2/AAL5 and the U-plane performs signal processing such as PDCP/RLC/MAC, andfull spelling and definitions are specified in 3GPP, therefore no description is made on them herein.

In interfaces between the RNC20 and CN10, RNC30 and Node B40, the control of transport resources with an identifier of CID by the ALCAP protocol is as described above. The present invention is configured so that the transport resources of the respective interfaces Iu, Iur and Iub may be controlled with a protocol called a transport control protocol 200 between the T-plane 21 and the C-plane 22. For this purpose, in the T-plane 21, there are provided a transport resource control section 201 and a control section 202. The transport resource control section 201 controls transport resources and the control section 202 controls the whole T-plane including the control section 201.

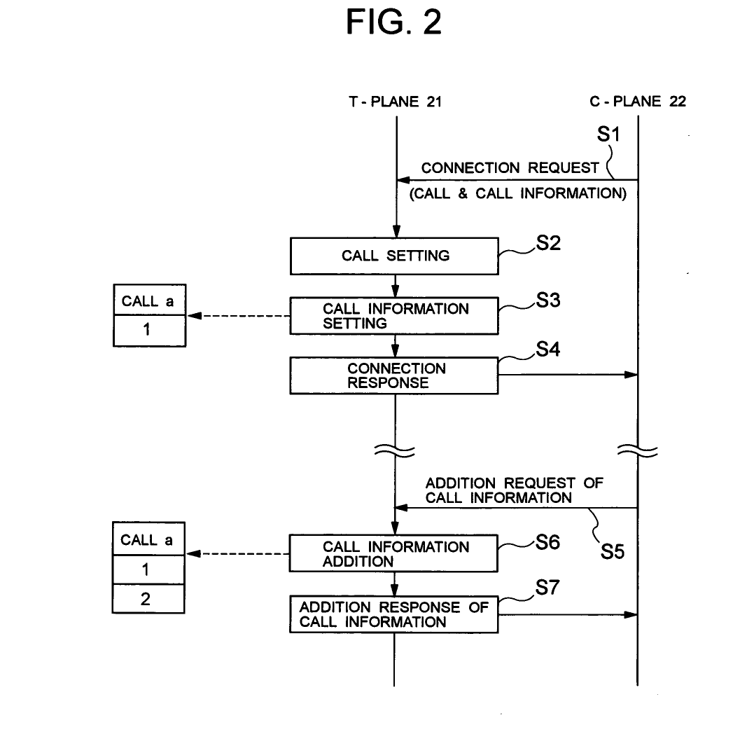

FIG. 2 is a sequence diagram illustrating operations of one embodiment of the present invention. The T-plane 21 starts setting transport resources required for communications with an external apparatus, for example, when a connection request is received from the C-plane 22 (step S1). That is, the transport resource control section 201 produces a call “a” in response to the connection request (step S2) and sets call information required for communications with the external apparatus, for example, “1” (step S3). The call “a” is linked with the call information “1”, which are stored in a memory table (not illustrated) provided in the transport resource control section 201. The connection request in step S1 is a request signal for setting both of a call and call information. When the setting of the call and the call information is completed, the transport resource control section 201 transmits a connection request (step S4).

When an addition request of call information to the call “a” received from the C-plane 22 in this state (step S5), the transport resource control section 201 adds new call information, for example, “2” to the call “a” (step S6). At this time, “2” is further added to the call “a” besides the call information “1”, which are stored in the memory table. When the addition setting of the call information is completed, the transport resource control section 201 transmits an addition response of call information (step S7).

According to the above-mentioned procedures, the T-plane 21 can communicate with the external apparatus, using a call “a” and the two types of call information “1”, “2” set to the call “a”.

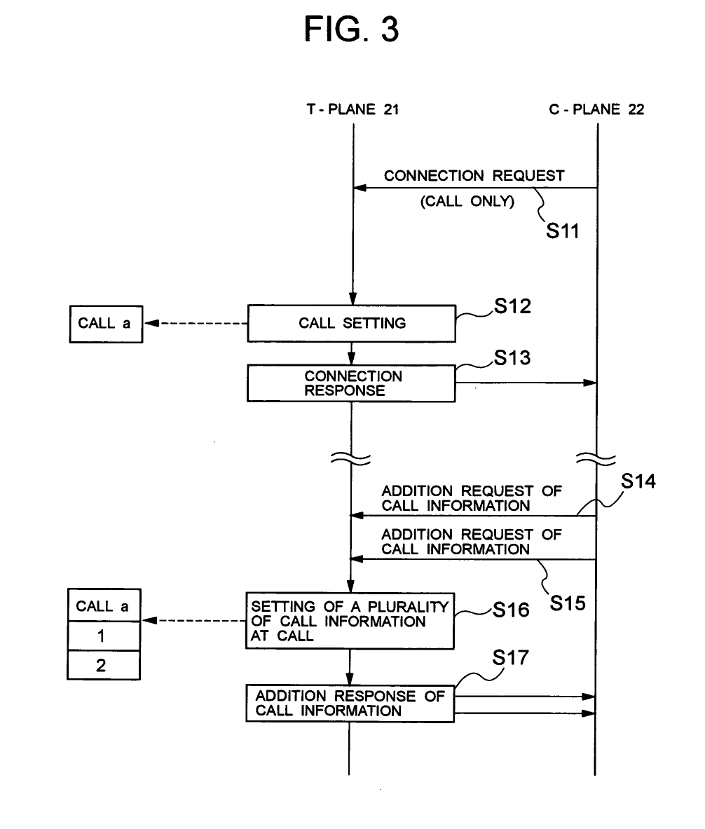

FIG. 3 is a sequence diagram illustrating operations of another embodiment of the present invention. The T-plane 21, when a connection request is received, for example, from the C-plane 22 (step S11), sets a call “a” by the transport resource control section 201 in response to the request (step S12) . At this time, it is assumed that the connection request in the step S11 is only a call setting request, not including a call information setting request. Accordingly, only call “a” setting is made without any call information setting. Upon completion of the call setting, the transport resource control section 201 transmits a connection response (step S13).

Assuming that the T-plane 21 receives a plurality of addition requests of call information from the C-plane 22 (steps S14, S15) under this state, the T-plane 21 may receive the plurality of addition requests of call information at the same time if a request source does not perform waiting processing at the time of transmitting a request in response to the addition requests of call information. The transport resource control section 201 responds to the plurality of addition requests of call information, links them with a call “a” and sets several pieces of call information (step S16) . For example, call information “1”, “2” are additionally set and stored in a memory table. Then, the transport resource control section 201 transmits a plurality of addition responses of call information (step S17).

As an example where several (two) pieces of call information are given to one call, there is a case where a call uses two services of CS and PS at the same time. In this case, the Iu interface permits call information to be allocated to each service of CS and PS. Where the mobile terminal is in a soft hand-over state, call information corresponding the number of Nodes B communicating with a mobile terminal are allocated to each of Iur and Iub interfaces. Indication for allocating call information to the respective interfaces is supposed to be included in a connection request and an addition request of call information from the C-plane 22 shown in FIGS. 2 and 3.

If there is a possibility of a setting request of call information being made with a call unset, it should be avoided, therefore no setting or addition of call information is allowed until a connection response has been transmitted from the T-plane 21.

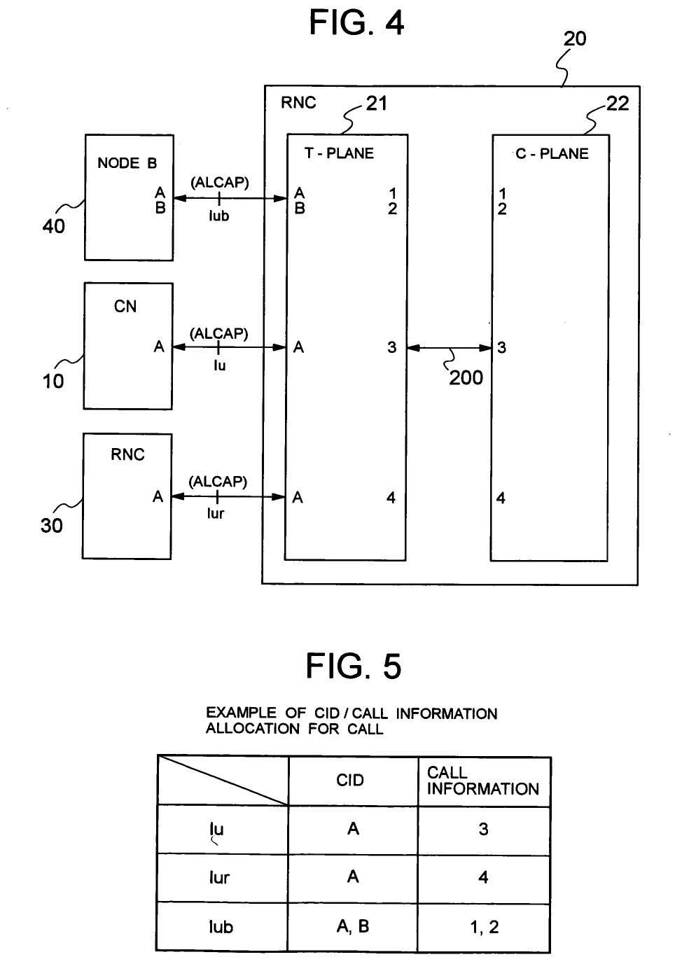

FIG. 4 is a block diagram for better understanding of aforementioned embodiment of the present invention. Portions equivalent to those in FIG. 1 are indicated with the same symbols. The transport resources through the respective interfaces Iu, Iur and Iub between the RNC20 and CN10, RNC30, Node B40 are controlled using the ALCAP protocol. That is, in controlling transport resources through the ALCAP, an identifier of CID is allocated for each interface, as described above. For example, CID such as “A” or “B” is used as illustrated.

On the other hand, between the T-plane 21 and the C-plane 11, transport resources through the respective interfaces between the T-plane 21 and CN10, RNC30, Node B40 is indirectly controlled using the transport control protocol 200. In this case, the transport resources through the ALCAP are controlled with identifiers such as “1”, “2”, “3” and “4”, namely, call information given for each call. FIG. 5 is a chart showing an example of CID/call information allocation in a call of FIG. 4. CIDs allocated by the ALCAP are independently allocated through the respective interfaces, and overlapped CIDs occur between the interfaces. In the present invention, however, unique call information is allocated for each call, thus causing no overlapping between the interfaces.

As described above, the C-plane 22 can control transport resources between the T-plane 21 and CN10, RNC30 and Node B40 indirectly, thus allowing physical separation of C-plane/T-plane of the RNC without affecting CN, RNC, Node B.

Because a call of mobile terminal is linked with call information of CID unit of the ALCAP, a W-CDMA mobile communication system can control transport resources with high independency. Furthermore, a single identifier is defined for a call of mobile terminal, therefore the system can control transport resources with high simplicity.

As a matter of course, operations according to the above-mentioned embodiment may be structured so as to be executed by storing its operating procedures in recording medium such as ROM as a program in advance and making a computer (CPU) read the procedures.

According to the present invention, by linking call for each mobile terminal with call information for each CID of ALCAP, transport resources can be controlled with high independency. In addition, according to the present invention, by defining an identifier as the single call information in the call for each mobile terminal, transport resources can be controlled with high simplicity.

What is claimed is:

1. A transport resource control system, used in a mobile communication system adaptable to communications through a mobile terminal by ensuring transport resources in respective interfaces between a core network, a radio network controller andabase station, wherein said system comprises control section for controlling the transport resources using call information as unique identification data at every call for the mobile terminal.

2. The transport resource control system according to claim 1, wherein the call information is obtained by linking the call with an identifier (CID) unit indicating a call associated with a protocol (ALCAP) ensuring the transport resources.

3. The transport resource control system according to claim 1, wherein the control section sets the call in response to a setting request of the call and sets the call information in response to a setting request of the call information to the call.

4. The transport resource control system according to claim 3, wherein the control section sets the call and the call information when the timing of a setting request of the call is the same as that of a setting request of the call information.

5. The transport resource control system according to claim 3, wherein the control section makes an addition setting of the call information in response to an addition request of call information to the call during a setting of the call.

6. The transport resource control system according to claim 1, wherein the control section independently sets the call information through each of the interfaces.

7. A transport resource control method, used in a mobile communication system adaptable to communications through a mobile terminal by ensuring transport resources in respective interfaces between a core network, a radio network controller and a base station, wherein saidmethod comprises a control step of controlling the transport resources using call information as unique identification data at every call for the mobile terminal.

8. The transport resource control method according to claim 7, wherein the call information is obtained by linking the call with an identifier (CID) unit indicating a call associated with a protocol (ALCAP) ensuring the transport resources.

9. The transport resource control method according to claim 7, wherein the control step sets the call in response to a setting request of the call and sets the call information in response to a setting request of the call information to the call.

10. The transport resource control method according to claim 9, wherein the control step sets the call and the call information when the timing of a setting request of the call is the same as that of a setting request of the call information.

11. The transport resource control method according to claim 9, where in the control step makes an addition setting of the call information in response to an addition request of call information to the call during a setting of the call.

12. The transport resource control method according to claim 7, wherein the control step independently sets the call information through each of the interfaces.

13. A radio network controller, used in a mobile communication system adaptable to communications through a mobile terminal by ensuring transport resources in respective interfaces between a core network, said radio network controller and a base station, wherein said radio network controller comprises control section for controlling the transport resources using call information as unique identification data at every call for the mobile terminal.

14. The radio network controller according to claim 13, wherein the call information is obtained by linking the call with an identifier (CID) unit indicating a call associated with a protocol (ALCAP) ensuring the transport resources.

15. The radio network controller according to claim 13, wherein the control section sets the call in response to a setting request of the call and sets the call information in response to a setting request of the call information to the call.

16. The radio network controller according to claim 15, wherein the control section sets the call and the call information when the timing of a setting request of the call is the same as that of a setting request of the call information.

17. The radio network controller according to claim 15, wherein the control section makes an addition setting of the call information in response to an addition request of call information to the call during a setting of the call.

18. The radio network controller according to claim 13, wherein the control section independently sets the call information through each of the interfaces.

19. A program, enabling a computer to perform operations of a radio network controller in a mobile communication system adaptable to communications through a mobile terminal by ensuring transport resources in respective interfaces between a core network, a radio network controller and a base station, wherein said program comprises aprocess of controlling the transport resources using call information as unique identification data at every call for the mobile terminal.
